(19) United States
(12) Patent Application Publication
(10) Pub. No.: US 2025/0132077 A1
(43) Pub. Date: Apr. 24, 2025

(54) COIL COMPONENT

(71) Applicant: SAMSUNG ELECTRO-MECHANICS CO., LTD., Suwon-si (KR)

(72) Inventors: Han LEE, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/885,448

(22) Filed: Sep. 13, 2024

(30) Foreign Application Priority Data
Oct. 19, 2023 (KR) 10-2023-0140358

(51) Int. Cl. H01F 5/04; H01F 27/28

(52) U.S. Cl. CPC H01F 5/04; H01F 27/2847

(57) ABSTRACT

A coil component includes: a body; a support member disposed inside the body and having one surface and another surface opposing each other; a first coil disposed on the one surface of the support member and including a first core; a second coil disposed on the other surface of the support member and including a second core; a first lead portion disposed on the other surface of the support member and connected to the first coil; and a second lead portion disposed on the one surface of the support member and connected to the second coil, in which the first core partially overlaps the second core when viewed in a stacking direction of the first and second coils on the support member, and a length of the second coil in one direction is larger than a length of the first coil in the one direction.

### CROSS-REFERENCE TO RELATED APPLICATION(S)

This application claims benefit of priority to Korean Patent Application No. 10-2023-0140358 filed on Oct. 19, 2023 in the Korean Intellectual Property Office, the disclosure of which is incorporated herein by reference in its entirety.

### TECHNICAL FIELD

The present disclosure relates to a coil component.

### BACKGROUND

In accordance with miniaturization and thinning of electronic devices such as a digital television (TV), a mobile phone, and a laptop computer, miniaturization and thinning of coil components used in such electronic devices have been demanded. In order to satisfy such demand, research and development of various winding type or thin film type coil components have been actively conducted.

A main issue with the miniaturization and the thinning of the coil component is to implement the same characteristics as characteristics of an existing coil component in spite of the miniaturization and the thinning. In order to satisfy such a demand, a ratio of a magnetic material in a core in which the magnetic material is filled should be increased. However, there is a limitation in increasing the ratio due to a change in strength of a body of an inductor, frequency characteristics depending on an insulation property, and the like.

At the same time, a demand for an array type component having an advantage of reducing a mounting area of coil components has also increased. Such an array type coil electronic component may have a non-coupled or coupled inductor form or a mixed form of the non-coupled inductor form and the coupled inductor form depending on a coupling coefficient or a mutual inductance between a plurality of coil portions.

In a coupled inductor, leakage inductance is associated with an output current ripple, and mutual inductance is associated with an inductor current ripple. In order for the coupled inductor to have the same output current ripple as that of an existing non-coupled inductor, the leakage inductance of the coupled inductor should be the same as a mutual inductance of the existing non-coupled inductor. In addition, when the mutual inductance is increased, a coupling coefficient k is increased, so that the inductor current ripple may be decreased.

Therefore, when the coupled inductor may have a decreased inductor current ripple while having the same output current ripple as that of the existing non-coupled inductor at the same size as that of the existing non-coupled inductor, an increase in efficiency may be achieved without an increase in mounting area. In order to increase the efficiency of the inductor array while maintaining a size of the inductor array, a coupled inductor of which a coupling coefficient is increased by increasing a mutual inductance may be needed. On the other hand, depending on the needs of the application, a coupled inductor having a relatively small coupling coefficient may be required, in which case the coupling coefficient between the coil portions needs to be decreased to an appropriate level.

### SUMMARY

An aspect of the present disclosure is to enable effective control of coupling inductance between coil portions in a coil component having a coupled inductor structure.

Another aspect of the present disclosure is to enable efficient control of a characteristic deviation between coil portions in a coil component having a coupled inductor structure.

According to an aspect of the present disclosure, a coil component includes a body having a first surface and a second surface opposing each other in a first direction, a third surface and a fourth surface opposing each other in a second direction, and a fifth surface and a sixth surface opposing each other in a third direction; a support member disposed inside the body and having one surface and another surface opposing each other; a first coil disposed on the one surface of the support member and having a first core; a second coil disposed on the other surface of the support member and having a second core; a first lead portion disposed on the other surface of the support member and connected to the first coil; and a second lead portion disposed on the one surface of the support member and connected to the second coil, in which the first core partially overlaps the second core when viewed in the third direction of the body, and a length of the second coil in the first direction is larger than a length of the first coil in the first direction.

According to another aspect of the present disclosure, a coil component includes a body having a first surface and a second surface opposing each other in a first direction, a third surface and a fourth surface opposing each other in a second direction, and a fifth surface and a sixth surface opposing each other in a third direction; a first coil disposed inside the body and including a first core; and a second coil disposed to be spaced apart from the first coil inside the body and including a second core, in which the first core includes a first shared core that overlaps the second core in the third direction, and a first non-shared core that does not overlap the second core in the third direction, the second core includes a second shared core that overlaps the first core in the third direction, and a second non-shared core that does not overlap the first core in the third direction, the first and second non-shared cores are disposed closer to the second surface of the body than the first and second shared cores, and an area of the second non-shared core is larger than an area of the first non-shared core.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic transparent perspective view illustrating a coil component according to a first exemplary embodiment in the present disclosure;

FIG. 2 is an exploded perspective view illustrating some components of the coil component of FIG. 1;

FIG. 3 is a view illustrating the coil component of FIG. 1 when viewed from above;

FIG. 4 is an enlarged view of part A of FIG. 3;

FIG. 5 is a view illustrating coils of the coil component of FIG. 1;

FIG. 6 is a virtual plan view in which the coils and lead portions of the coil component of FIG. 1 overlap each other;

FIGS. 7A and 7B are cross-sectional views taken along lines I-I′ and II-II′ of FIG. 1;

FIG. 8 is a schematic transparent perspective view illustrating a coil component according to a second exemplary embodiment in the present disclosure;

FIG. 9 is a transparent perspective view illustrating a coil component according to a comparative example in the present disclosure;

FIG. 10 is a view illustrating the coil component of FIG. 9 when viewed from above; and

FIGS. 11A and 11B are cross-sectional views taken along lines III-III′ and IV-IV′ of FIG. 9.

### DETAILED DESCRIPTION

Terms used in the present specification are used only in order to describe specific exemplary embodiments rather than limiting the present disclosure. Singular forms are intended to include plural forms unless the context clearly indicates otherwise. It is to be understood that the terms “include” or “have” used here specify the presence of features, numbers, steps, operations, components, parts, or combinations thereof mentioned in the present specification, or combinations thereof, but do not preclude the presence or addition of one or more other features, numbers, steps, operations, components, parts, or combinations thereof. In addition, throughout the specification, “on” does not necessarily mean that any element is positioned on an upper side based on a gravity direction, but means that any element is positioned above or below a target portion.

Further, a term “couple” not only refers to a case in which respective components are in physically direct contact with each other, but also refers to a case where the respective components are in contact with another component with another component interposed therebetween, in a contact relationship between the respective components.

Since sizes and thicknesses of the respective components illustrated in the drawings are arbitrarily illustrated for convenience of explanation, the present disclosure is not necessarily limited to those illustrated in the drawings.

In the drawings, an X-direction refers to a first direction or a length direction, a Y-direction refers to a second direction or a width direction, and a Z-direction refers to a third direction or a thickness direction.

Hereinafter, coil components according to exemplary embodiments in the present disclosure will be described in detail with reference to the accompanying drawings. In describing exemplary embodiments in the present disclosure with reference to the accompanying drawings, components that are the same as or correspond to each other will be denoted by the same reference numerals, and an overlapping description thereof will be omitted.

Various kinds of electronic components may be used in electronic devices, and various kinds of coil components may be appropriately used between these electronic components depending on their purposes in order to remove noise, or the like.

That is, the coil components used in the electronic devices may be a power inductor, high frequency (HF) inductors, a general bead, a bead for a high frequency (GHz), a common mode filter, and the like.

### First Exemplary Embodiment

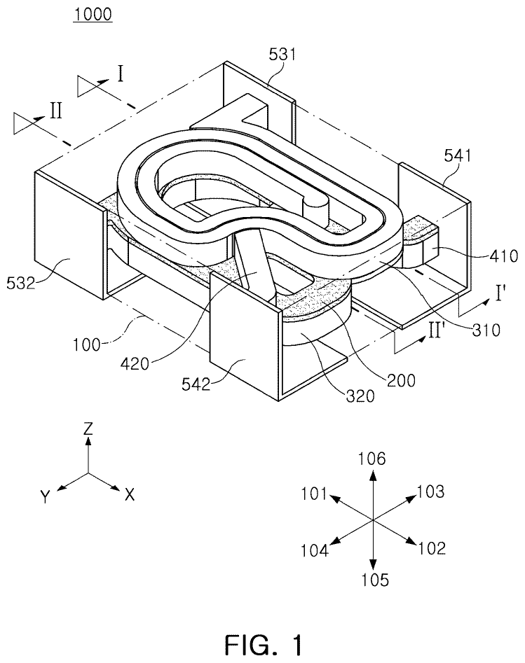

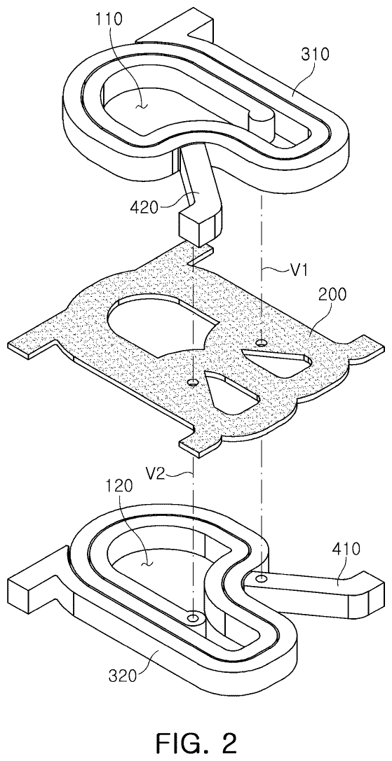

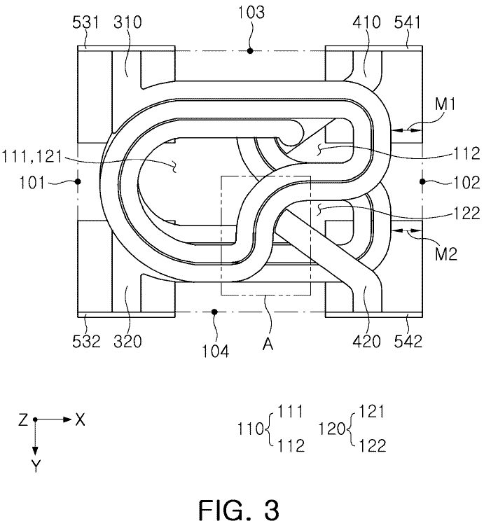

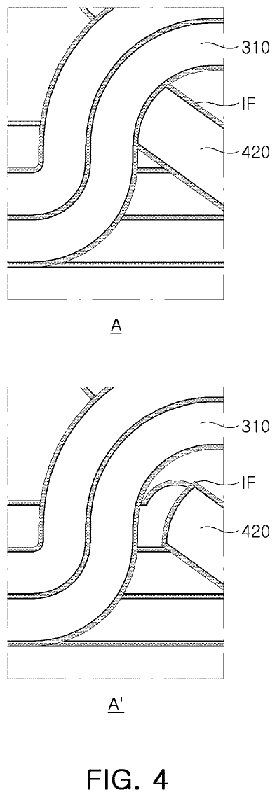

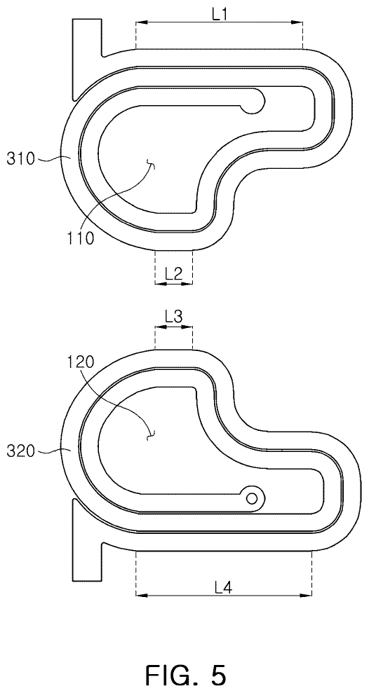

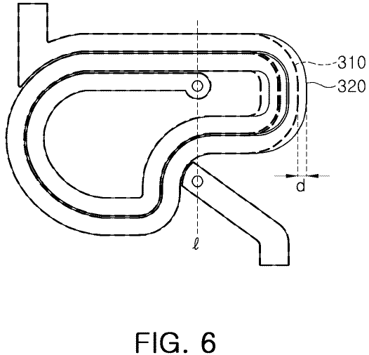

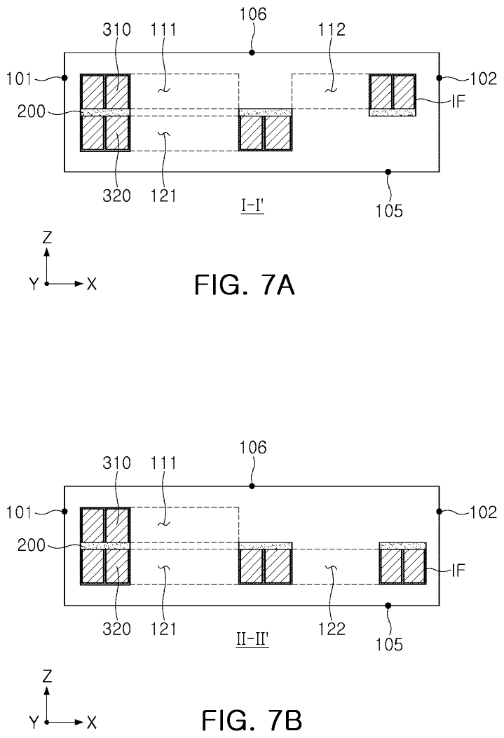

FIG. 1 is a schematic transparent perspective view illustrating a coil component according to a first exemplary embodiment in the present disclosure. FIG. 2 is an exploded perspective view illustrating some components of the coil component of FIG. 1. FIG. 3 is a view illustrating the coil component of FIG. 1 when viewed from above. FIG. 4 is an enlarged view of part A of FIG. 3. FIG. 5 is a view illustrating coils of the coil component of FIG. 1. FIG. 6 is a virtual plan view in which the coils and lead portions of the coil component of FIG. 1 overlap each other. FIGS. 7A and 7B are cross-sectional views taken along lines I-I′ and II-II′ of FIG. 1.

Referring to FIGS. 1 through 7B, a coil component 1000 according to an exemplary embodiment in the present disclosure may include a body 100, a support member 200, a first coil 310, a second coil 320, a first lead portion 410, a second lead portion 420, and external electrodes 531, 541, 532, and 542.

The body 100 may form an overall appearance of the coil component 1000 according to the present exemplary embodiment, and may embed the coils 310 and 320 and the lead portions 410 and 420 therein.

The body 100 may generally have a hexahedral shape.

In FIG. 1, the body 100 may have a first surface 101 and a second surface 102 opposing each other in the X-direction (first direction), a third surface 103 and a fourth surface 104 opposing each other in the Y-direction (second direction), and a fifth surface 105 and a sixth surface 106 opposing each other in the Z-direction (third direction). The first to fourth surfaces 101, 102, 103, and 104 of the body 100 may correspond to side surfaces of the body 100 that connect the fifth surface 105 and the sixth surface 106 of the body 100 to each other. Hereinafter, upper and lower surfaces of the body 100 may refer to the sixth and fifth surfaces 106 and 105 of the body 100 determined on the basis of directions of FIG. 1, respectively. The fifth surface 105 of the body 100 may serve as a mounting surface when mounting the coil component. However, the mounting surface is not necessarily limited thereto.

The body 100 may include a resin and a magnetic material. Specifically, the body 100 may be formed by stacking one or more magnetic composite sheets in which the magnetic material is dispersed in the resin. The magnetic material may be ferrite or metal magnetic powder. The ferrite may be, for example, at least one of spinel type ferrite such as Mg—Zn-based ferrite, Mn—Zn-based ferrite, Mn—Mg-based ferrite, Cu—Zn-based f ferrite, Mg—Mn—Sr-based ferrite, or Ni—Zn-based ferrite, hexagonal ferrite such as Ba—Zn-based ferrite, Ba—Mg-based ferrite, Ba—Ni-based ferrite, Ba—Co-based ferrite, or Ba—Ni—Co-based ferrite, garnet type ferrite such as Y-based ferrite, or Li-based ferrite. The metal magnetic powder may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder may be at least one of pure iron powder, Fe—Si-based alloy powder, Fe—Si—Al-based alloy powder, Fe—Ni-based alloy powder, Fe—Ni—Mo-based alloy powder, Fe—Ni—Mo—Cu-based alloy powder, Fe—Co-based alloy powder, Fe—Ni—Co-based alloy powder, Fe—Cr-based alloy powder, Fe—Cr—Si-based alloy powder, Fe—Si—Cu—Nb-based alloy powder, Fe—Ni—Cr-based alloy powder, or Fe—Cr—Al-based alloy powder. The metal magnetic powder may be amorphous or crystalline. For example, the metal magnetic powder may be Fe—Si—B—Cr based amorphous alloy powder, but is not necessarily limited thereto. The ferrite and the metal magnetic powder may each have an average diameter of about 0.1 μm to 30 μm, but are not limited thereto. The body 100 may include two or more kinds of magnetic materials dispersed in the resin. Here, different kinds of magnetic materials mean that the magnetic materials dispersed in the resin are distinguished from each other by any one of an average diameter, a composition, crystallinity, and a shape. The resin may include epoxy, polyimide, liquid crystal polymer (LCP), or the like, or mixtures thereof, but is not limited thereto.

The support member 200 may be disposed inside the body 100. Specifically, the support member 200 may be embedded in the body 100. The support member 200 may be configured to support the coils 310 and 320 and the lead portions 410 and 420 described below. However, according to some exemplary embodiments, the support member 200 may not be provided. For example, in a case where a winding type coil is used, the support member 200 may not need to be separately provided. The coil component 1000 according to the first exemplary embodiment may relate to a thin film type coil in which electroplating is performed on the support member 200.

The support member 200 may be formed of an insulating material including a thermosetting insulating resin such as an epoxy resin, a thermoplastic insulating resin such as a polyimide resin, or a photosensitive insulating resin or be formed of an insulating material having a reinforcing material such as a glass fiber or an inorganic filler impregnated in such an insulating resin. As an example, the support member 200 may be formed of an insulating material such as prepreg, an Ajinomoto Build-up Film (ABF), FR-4, a Bismaleimide Triazine (BT) film, or a photoimagable dielectric (PID) film, but is not limited thereto.

As a material of the inorganic filler, one or more materials selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used.

In a case in which the support member 200 is formed of the insulating material including the reinforcing material, the support member 200 may provide more excellent rigidity. In a case in which the support member 200 is formed of an insulating material that does not include a glass fiber, the support member 200 may be advantageous in thinning the coil component. In a case in which the support member 200 is formed of the insulating material including the photosensitive insulating resin, the number of processes for forming a coil 300 may be decreased, which may be advantageous in reducing a production cost and may be advantageous in forming fine vias.

The first and second coils 310 and 320 may be disposed to be spaced apart from each other in the body 100 to implement characteristics of the coil component 1000 according to the present exemplary embodiment. For example, the coil component 1000 according to the present exemplary embodiment may be a coupled inductor in which an absolute value of a coupling coefficient k between the first and second coils 310 and 320 exceeds 0 and is less than or equal to 1, but is not limited thereto.

The first coil 310 may include a first core 110, and the second coil 320 may include a second core 120. Since the first coil 310 forms at least one turn around the first core 110, the first core 110 may be defined as a region inside the turn formed by the first coil 310. Likewise, since the second coil 320 forms at least one turn around the second core 120, the second core 120 may be defined as a region inside the turn formed by the second coil 320. Since the first coil 310 and the second coil 320 are spaced apart from each other in the Z-direction (third direction) as described below, the first core 110 and the second core 120 may be spaced apart from each other in the third direction of the body 100.

The cores 110 and 120 may be formed by filling through-holes of the first and second coils 310 and 320 with at least parts of the magnetic composite sheets when stacking and curing the magnetic composite sheets, but are not limited thereto.

An area of the second core 120 may be larger than that of the first core 110. In addition, the first core 110 and the second core 120 may partially overlap each other and include a shared core and a non-shared core, which will be described in detail after the description of the coil 300.

Hereinafter, the coils 310 and 320 and the lead portions 410 and 420 of the coil component according to the present exemplary embodiment will be described in detail with reference to FIGS. 2 through 6.

FIG. 2 is an exploded perspective view illustrating some components of the coil component of FIG. 1. Specifically, FIG. 2 is a view illustrating the coils 310 and 320 and the lead portions 410 and 420 of the coil component 1000 according to the present exemplary embodiment. FIG. 3 is a view illustrating the coil component of FIG. 1 when viewed from above. For convenience, the support member 200 is omitted in FIG. 3.

Referring to FIGS. 2 and 3, the first coil 310 may be disposed on one surface (an upper surface in FIGS. 2 and 3) of the support member 200 and may form at least one turn around the first core 110. The other end of the first coil 310 may be connected to the first lead portion 410 described below through a first via V1. One end of the first coil 310 may extend to the third surface 103 of the body 100.

FIG. 5 is a view illustrating the coils 310 and 320 of the coil component of FIG. 1. Referring to FIG. 5, the first coil 310 may have a first straight portion L₁ and a second straight portion L₂, the first straight portion L₁ being adjacent to the third surface 103 of the body 100 and being substantially parallel to the third surface 103 of the body 100, and the second straight portion L₂ being adjacent to the fourth surface 104 of the body 100 and being substantially parallel to the fourth surface 104 of the body 100. Here, the straight portion may refer to the outermost coil portion whose curvature is substantially 0. That is, since the straight portion is substantially parallel to the third and fourth surfaces 103 and 104 of the body 100, the curvature thereof may be substantially 0. In one or more aspects, the terms “about,” “substantially,” and “approximately” may provide an industry-accepted tolerance for their corresponding terms and/or relativity between items, such as a tolerance of from less than one percent to 10 percent of the actual value stated, and other suitable tolerances.

Referring to FIGS. 2 and 3, the second coil 320 may be disposed on the other surface (a lower surface in FIGS. 2 and 3) of the support member 200 and may form at least one turn around the second core 120. The other end of the second coil 320 may be connected to the second lead portion 420 described below through a second via V2. One end of the second coil 320 may extend to the fourth surface 104 of the body 100.

The second coil 320 may be disposed closer to the fifth surface 105 of the body 100 than the first coil 310. The fifth surface 105 of the body 100 may serve as the mounting surface when mounting the coil component.

Referring to FIG. 5, the second coil 320 may have a third straight portion L₃ and a fourth straight portion L₄, the third straight portion L₃ being adjacent to the third surface 103 of the body 100 and being substantially parallel to the third surface 103 of the body 100, and the fourth straight portion L₄ being adjacent to the fourth surface 104 of the body 100 and being substantially parallel to the fourth surface 104 of the body 100. Here, the straight portion may refer to the outermost coil portion whose curvature is substantially 0. That is, since the straight portion is substantially parallel to the third and fourth surfaces 103 and 104 of the body 100, and thus, the curvature thereof may be substantially 0.

In one embodiment, the first coil 310 may further include a first curved portion and a second curved portion. The first curved portion may extend between one end of the first straight portion L₁ and one end of the second straight portion L₂, and the second curved portion may extend between another end of the first straight portion L₁ and another end of the second straight portion L₂. Here, the first curved portion may be closer to the first surface 101 of the body 100 than the second curved portion.

In one embodiment, the second coil 320 may further include a third curved portion and a fourth curved portion. The third curved portion may extend between one end of the third straight portion L₃ and one end of the fourth straight portion L₄, and the fourth curved portion may extend between another end of the third straight portion L₃ and another end of the fourth straight portion L₄. Here, the third curved portion may be closer to the first surface 101 of the body 100 than the fourth curved portion.

In one embodiment, the second curved portion and the fourth curved portion each may have at least two bent portions so as to form an ‘S’ shape, and the first curved portion and the third curved portion may have a semi-circular shape.

In one embodiment, the first lead portion 410 may be exposed to the third surface 103 of the body 100, connected to the first coil 310, and extending diagonally toward one of the at least two bent portions of the fourth curved portion. The second lead portion 420 may be exposed to the fourth surface 104 of the body 100, connected to the second coil 320, and extending diagonally toward one of the at least two bent portions of the second curved portion.

Hereinafter, the shapes and sizes of the coils 310 and 320, which are the characteristic components of the present disclosure, will be described in more detail.

In a coupled inductor according to the related art, a first coil and a second coil have the same shape and size. A coil close to a mounting surface of the coil component has a problem that a magnetic flux and a capacity are decreased due to an influence of a land pattern of the mounting surface or a metal layer of a substrate. As a result, a characteristic deviation between coil portions occurs in the coupled inductor.

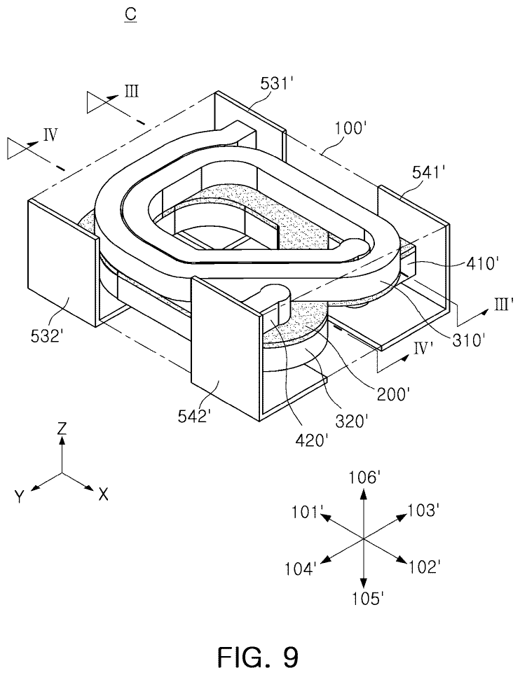

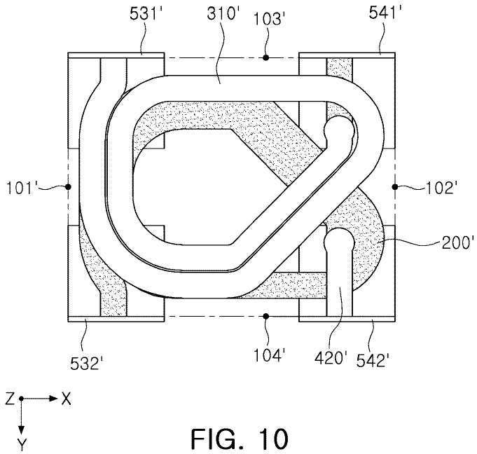

FIG. 9 is a transparent perspective view illustrating a coil component C according to a comparative example in the present disclosure. FIG. 10 is a view illustrating the coil component of FIG. 9 when viewed from above.

Referring to FIGS. 9 and 10, in the coil component C according to the comparative example, first and second coils 310′ and 320′ have the same shape and size. Accordingly, a magnetic flux and a capacity of the second coil 320′ close to a fifth surface 105′ provided as a mounting surface may be decreased when mounting the coil component.

In this regard, the coil component according to an exemplary embodiment in the present disclosure proposes the following structure to solve the above problem.

FIG. 6 is a virtual plan view in which the coils and the lead portions of the coil component of FIG. 1 overlap each other.

A length of the second coil 320 of the coil component according to an exemplary embodiment in the present disclosure in the first direction may be larger than a length of the first coil 310 in the first direction. Here, the “length of each of the coils 310 and 320 in the first direction” may mean a straight-line distance from one end of each of the coils 310 and 320 to the opposite end in the first direction.

The length of the second coil 320 in the first direction may be larger than that of the first coil 310 by d. As an example, a value of d may be 0.015 mm (15 μm). However, the value of d is not necessarily limited thereto and may be changed depending on the size and characteristics of the coil component.

As described below, the second core 120 formed by the second coil 320 may be larger than the first core 110 formed by the first coil 310. Specifically, an area of a second non-shared core 122 in the second core 120 may be larger than an area of a first non-shared core 112 in the first core 110. That is, the length of the second coil 320 in the first direction may be designed to be larger than the length of the first coil 310 in the first direction to make the area of the second core 120 larger than the area of the first core 110.

Specifically, a spare space may be secured on the first and second surfaces 101 and 102 of the body 100 than on the third and fourth surfaces 103 and 104 of the body 100 to which the lead portions extend. Therefore, the length of the coil may be designed to be different by using the spare space of the coil component in the first direction.

The lengths of the coils 310 and 320 in the first direction may be measured in the following manner. First, the coil component may be polished to reveal a cross-section in the first direction and the third direction to prepare a cross-sectional sample with the vias V1 and V2 exposed. The prepared cross-sectional sample may be observed using an optical microscope or the like, and the length of each of the coils 310 and 320 in the first direction may be measured. As described above, the “length of each of the coils 310 and 320 in the first direction” may mean the straight-line distance from one end of each of the coils 310 and 320 to the opposite end in the first direction. The measurement may be performed multiple times (for example, 10 times), and an arithmetic average of the measured values may be obtained as the length.

Meanwhile, a length of the second coil 320 in the second direction may be substantially the same as a length of the first coil 310 in the second direction. However, the lengths of the first and second coils 310 and 320 in the second direction are not necessarily limited thereto, and may be different from each other depending on required characteristics of the coil component.

The second coil 320 may be disposed closer to the second surface 102 of the body 100 than the first coil 310. Referring to FIG. 3, a distance M1 between the first coil 310 and the second surface 102 is larger than a distance M2 between the second coil 320 and the second surface 102.

A length of the fourth straight portion L₄ of the second coil 320 may be larger than a length of the first straight portion L₁ of the first coil 310. As described above, the length of the second coil 320 in the first direction is larger than the length of the first coil 310 in the first direction, and thus, the length of the fourth straight portion L₄ of the second coil 320 may be larger than the length of the first straight portion L₁ of the first coil 310. The fourth straight portion L₄ of the second coil 320 may be disposed closer to the second surface 102 of the body 100 than the first straight portion L₁ of the first coil 310.

A distance between the first coil 310 and the first surface 101 of the body 100 may be substantially the same as a distance between the second coil 320 and the first surface 101 of the body 100. That is, the length of the coil may be designed to be different by utilizing the spare space on any one of the first surface 101 and the second surface 102 of the body 100. Here, the substantially same distance refers to a distance including a process error or a positional deviation occurring during manufacturing and an error occurring during measurement. As an example, when the vias V1 and V2 of the coils overlap each other so as to be aligned at the same position on an axis along the first direction as illustrated in FIG. 6, one ends of the coils 310 and 320 may be aligned in the first direction.

The length of the first straight portion L₁ may be larger than a length of the second straight portion L₂. The length of the fourth straight portion L₄ may be larger than a length of the third straight portion L₃.

That is, the first and second coils 310 and 320 may each have two straight portions substantially parallel to the third and fourth surfaces 103 and 104 of the body 100, and a length of one straight portion may be larger than that of the other straight portion. Accordingly, the cores 110 and 120 may have a trapezoidal shape when viewed in the third direction (Z-direction), but the shapes of the cores 110 and 120 are not necessarily limited thereto.

The first straight portion L₁ may be disposed closer to the second surface 102 of the body 100 than the second straight portion L₂, and the fourth straight portion L₄ may be disposed closer to the second surface 102 of the body 100 than the third straight portion L₃. Accordingly, the cores 110 and 120 may not have a trapezoidal shape when viewed in the third direction (Z-direction). In addition, as described below, first and second shared cores 111 and 121 may be disposed closer to the first surface 101 of the body 100 than the first and second non-shared cores 112 and 122, and the first and second non-shared cores 112 and 122 may be disposed closer to the second surface 102 of the body 100 than the first and second shared cores 111 and 121.

The first lead portion 410 may be disposed on the other surface of the support member 200 and may be connected to the first coil 310 through the first via V1. The first lead portion 410 may not form a turn around the first core 110. The first lead portion 410 may extend to the third surface 103 of the body 100.

The second lead portion 420 may be disposed on one surface of the support member 200 and may be connected to the second coil 320 through the second via V2. The second lead portion 420 may not form a turn around the second core 120. The second lead portion 420 may extend to the fourth surface 104 of the body 100.

The first coil 310 may be disposed on one surface of the support member 200 together with the second lead portion 420, and the second coil 320 may be disposed on the other surface of the support member 200 together with the first lead portion 410. That is, the first and second coils 310 and 320 are disposed to be staggered on the support member 200.

In this case, areas of the shared cores 111 and 121 of the first and second cores 110 and 120 described below may be maximized, and a magnetic flux density may be uniform throughout the coil component. In addition, space utilization may be enhanced compared to an existing coil component.

FIG. 4 is an enlarged view of part A of FIG. 3. Referring to A of FIG. 4, only an insulating film IF described below may be disposed between the first coil 310 and the second lead portion 420. In this case, the area of the second non-shared core 122 may be maximized, which may be more advantageous in reducing the characteristic deviation of the coil component. However, the first coil 310 and the second lead portion 420 are not necessarily limited thereto, and a portion of the body 100 may be disposed between the first coil 310 and the second lead portion 420 as illustrated in A′ of FIG. 4.

The first via V1 may connect the other end of the first coil 310 and the first lead portion 410. The first and second external electrodes 531 and 541 described below are disposed on the third surface 103 of the body 100 and may thus be connected to one end of the first coil 310 and the first lead portion 410, respectively. In such a manner, the first coil 310 may function as a single coil extending to the first lead portion 410.

The second via V2 may connect the other end of the second coil 320 and the second lead portion 420. The third and fourth external electrodes 532 and 542 described below are disposed on the fourth surface 104 of the body 100 and are thus connected to one end of the second coil 320 and the second lead portion 420. As a result, the second coil 320 may function as a single coil extending to the second lead portion 420.

Referring to FIG. 6, the first and second vias V1 and V2 may be disposed together on a line segment 1 parallel to the second direction of the body 100. Specifically, when the coils 310 and 320 overlap each other in such a way that one ends of the coils 310 and 320 are aligned in the first direction as illustrated in FIG. 6, the vias V1 and V2 may be disposed at the same position on the axis along the first direction. That is, a length difference between the coils 310 and 320 may occur on a right side with respect to the vias V1 and V2, and the length difference between the coils 310 and 320 may not occur on a left side with respect to the vias V1 and V2. In this way, as the length difference between the coils occurs on the right side with respect to the vias V1 and V2, an area difference between the first and second non-shared cores 112 and 122 described below may occur.

Meanwhile, in the actual coil component, the first and second vias V1 and V2 may be disposed together on a line segment parallel to the second direction of the body, but the positions of the first and second vias V1 and V2 are not necessarily limited thereto. As an example, even in a case in which the first and second coils 310 and 320 are shifted from each other in the actual coil component, when the coils are aligned and overlap each other as illustrated in FIG. 6, the vias V1 and V2 may be disposed at the same position on the axis along the first direction.

The coils 310 and 320 and the lead portions 410 and 420 may be plating patterns formed by a plating method used in the related art, such as a pattern plating method, an anisotropic plating method, or an isotropic plating method, and may be formed to have a multilayer structure by using a plurality of methods among the methods. That is, the coil component 1000 according to the first exemplary embodiment may be a thin film type inductor.

Each of the coils 310 and 320 and the lead portions 410 and 420 may include a seed layer that is in contact with the support member 200 and a plating layer disposed on the seed layer. The seed layer may be formed by a thin film formation method such as sputtering or an electroless plating method. In a case in which the seed layer is formed by the thin film formation method such as sputtering, at least a part of a material of the seed layer may permeate into the surface of the support member 200. This may be confirmed through the fact that a difference occurs in a concentration of a metal material of the seed layer on the support member 200 in the third direction of the body 100.

The via may include one or more conductive layers. As an example, in a case in which the via is formed by electroplating, the via may include a seed layer formed on an inner wall of a via hole penetrating through the support member 200 and an electroplating layer filling the via hole in which the seed layer is formed. The seed layer of the via may be formed integrally with the seed layers of the coils 310 and 320 in the same process or may be formed in a process different from a process of forming the seed layers of the coils 310 and 320 so that a boundary between the seed layer of the via and the seed layers of the coils 310 and 320 may be formed. The electroplating layer of the via may be formed integrally with the plating layers of the coils 310 and 320 in the same process or may be formed in a process different from a process of forming the plating layers of the coils 310 and 320 so that a boundary between the electroplating layer of the via and the plating layers of the coils 310 and 320 may be formed.

The coils 310 and 320, the lead portions 410 and 420, and the vias V may be formed of a metal having excellent electrical conductivity, such as silver (Ag), palladium (Pd), aluminum (Al), nickel (Ni), titanium (Ti), gold (Au), copper (Cu), platinum (Pt), or an alloy thereof.

Hereinafter, the cores 110 and 120 of the coil component according to the present exemplary embodiment will be described in detail with reference to FIGS. 2, 3, 7A, and 7B. FIGS. 7A and 7B are cross-sectional views taken along lines I-I′ and II-II′ of FIG. 1.

Referring to FIGS. 2 and 3, the first core 110 may include the first shared core 111 that overlaps the second core 120, and the first non-shared core 112 that does not overlap the second core 120. Here, “overlapping” may mean that the cores 110 and 120 overlap each other when viewed in an axial direction (third direction) of the cores 110 and 120. Accordingly, the first core 110 may include the first shared core 111 that overlaps the second core 120 in the third direction, and the first non-shared core 112 that does not overlap the second core 120 in the third direction.

Similarly, the second core 120 may include the second shared core 121 that overlaps the first core 110 and the second non-shared core 122 that does not overlap the first core 110. Specifically, the second core 120 may include the second shared core 121 that overlaps the first core 110 in the third direction and the second non-shared core 122 that does not overlap the first core 110 in the third direction.

The first and second shared cores 111 and 121 may refer to regions where the cores 110 and 120 overlap each other, and the areas of the first and second shared cores 111 and 121 may be substantially the same as each other. However, the first and second shared cores 111 and 121 may be spaced apart from each other in the third direction.

In the coil component 1000 according to an exemplary embodiment in the present disclosure, the coils 310 and 320 may be formed adjacent to each other while sharing the cores 110 and 120. Therefore, the coupling coefficient may be adjusted by appropriately increasing or decreasing a relative area ratio of the shared cores and the non-shared cores. As a result, a leakage inductance and a mutual inductance may be adjusted to desired values. The closer the value of the coupling coefficient to 1, the larger the coupling coefficient, and a negative (−) sign indicates negative coupling.

Hereinafter, the arrangement, shapes and sizes of the cores 110 and 120, which are the characteristic components of the present disclosure, will be described in more detail.

In a coupled inductor according to the related art, a first core and a second core have the same shape and size. A coil close to a mounting surface of the coil component has a problem that a magnetic flux and a capacity are decreased due to an influence of a land pattern of the mounting surface or a metal layer of a substrate. As a result, a characteristic deviation between coil portions occurs in the coupled inductor.

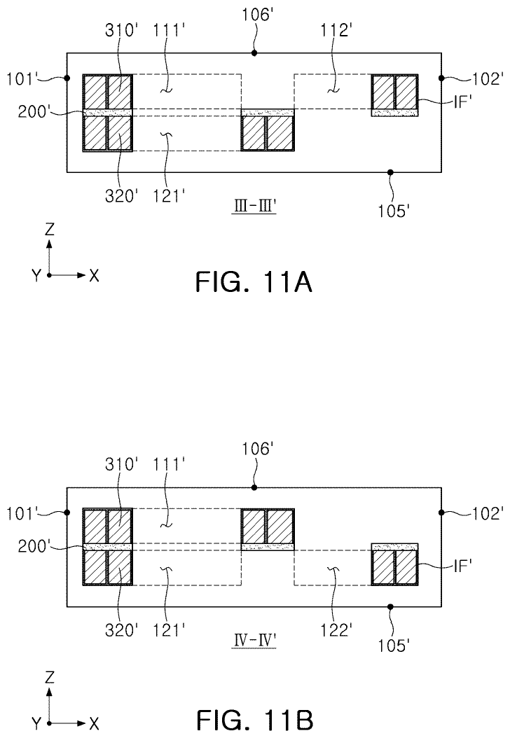

FIGS. 11A and 11B are cross-sectional views taken along lines III-III′ and IV-IV′ of FIG. 9.

Referring to FIGS. 11A and 11B, in the coil component C according to the comparative example, a first non-shared core 112′ and a second non-shared core 122′ have the same area.

Accordingly, a magnetic flux and a capacity of the second coil 320′ close to the fifth surface 105′ provided as the mounting surface may be decreased when mounting the coil component.

In this regard, the coil component according to an exemplary embodiment in the present disclosure proposes the following structure to solve the above problem.

In the coil component according to the present exemplary embodiment, the first and second non-shared cores 112 and 122 may be disposed closer to the second surface 102 of the body 100 than the first and second shared cores 111 and 121. Further, the area of the second non-shared core 122 may be larger than the area of the first non-shared core 112.

Referring to FIG. 3, the first and second non-shared cores 112 and 122 may be disposed on the same side (a right side in FIG. 3) with respect to the first and second shared cores 111 and 121. Therefore, coil misalignment due to process variations during coil formation may be minimized, thereby reducing the characteristic deviation of the coil component and increasing yield.

Referring to FIG. 7, the area of the second non-shared core 122 may be larger than the area of the first non-shared core 112. As described above, in the coil component according to the present exemplary embodiment, the length of the second coil 320 in the first direction may be larger than that of the first coil 310, and accordingly, the area of the second non-shared core 122 may be larger than the area of the first non-shared core 112. Since the area of the second non-shared core 122 is larger than the area of the first non-shared core 112 as described above, the characteristic deviation between the first and second coils 310 and 320 may be reduced.

Referring to FIGS. 3, 7A, and 7B, the first and second shared cores 111 and 121 may be disposed closer to the first surface 101 of the body 100 than the first and second non-shared cores 112 and 122.

Referring to FIG. 7, the first non-shared core 112 may be disposed closer to the sixth surface 106 of the body 100 than the second non-shared core 122, and the second non-shared core 122 may be disposed closer to the fifth surface 105 of the body 100 than the first non-shared core 112. Such disposition may result from the disposition of the first and second coils 310 and 320 forming the turns on one surface and the other surface of the support member.

Referring to FIG. 3, the first non-shared core 112 may be disposed closer to the third surface 103 of the body 100 than the second non-shared core 122, and the second non-shared core 122 may be disposed closer to the fourth surface 104 of the body 100 than the first non-shared core 112. The first and second non-shared cores 112 and 122 may be spaced apart from each other in the second direction and may thus not overlap each other.

The areas of the first and second shared cores 111 and 121 may be larger than the areas of the first and second non-shared cores 112 and 122. However, the areas of the first and second shared cores 111 and 121 are not limited thereto and may be smaller than the areas of the first and second non-shared cores 112 and 122. As the area of the non-shared core increases, the leakage inductance increases and the coupling coefficient k decreases accordingly.

The area of the second core 120 may be larger than that of the first core 110. As described above, the areas of the first and second shared cores 111 and 121 are the same as each other. Since the area of the second non-shared core 122 is larger than the area of the first non-shared core 112, the area of the second core 120 may be larger than that of the first core 110.

The following Table 1 is a table obtained by measuring an inductance Ls and a saturation current Isat in the coil component (inventive example) according to the present disclosure and the coil component according to the comparative example. Specifically, the inductance Ls and the saturation current Isat of the first coil (upper coil) and the second coil (lower coil) were measured separately. The inventive example is different from the comparative example in that the length of the second coil 320 in the first direction was increased by 0.015 mm (15 μm), and the remaining conditions were the same.

TABLE 1

| | Comparative Example | | Inventive Example | |
|---|---|---|---|---|
| | First Coil | Second Coil | First Coil | Second Coil |
| Ls [nH] | 100.5 | 98.5 | 99.7 | 99.7 |
| Isat [A] | 12.7 | 12.4 | 12.5 | 12.5 |

Referring to Table 1, it may be seen that deviations in inductance Ls and saturation current Isat between the coils 310 and 320 in the inventive example were reduced compared to the comparative example. This is because, as described above, the length of the second coil 320, which is the lower coil, in the first direction is increased to increase the area of the second non-shared core 122.

The insulating film IF may be formed on the support member 200, the coils 310 and 320, and the lead portions 410 and 420. Hereinafter, for convenience, the lead portions will also be described as a part of the coil 300.

The insulating film IF may be provided to insulate the coil 300 from the body 100, and may include any known insulating material such as parylene. The insulating material included in the insulating film IF is not particularly limited, but may be any insulating material. The insulating film IF may be formed by a method such as vapor deposition, but is not limited thereto, and may be formed by stacking insulation films on both surfaces of the support member 200. In the former case, the insulating film IF may be formed in the form of a conformal film along the surfaces of the support member 200 and the coil 300. Meanwhile, in the present disclosure, the insulating film IF is an optional component. Therefore, when the body 100 has a sufficient insulation resistance at an operating voltage and an operating current of the coil component 1000 according to the present exemplary embodiment, the insulating film IF may be omitted.

The first to fourth external electrodes 531, 541, 532, and 542 may be disposed outside the body 100 and connected to the coils 310 and 320 and the lead portions 410 and 420. Specifically, the first and second external electrodes 531 and 541 may be disposed on the third surface 103 of the body 100, and the third and fourth external electrodes 532 and 542 may be disposed on the fourth surface 104 of the body 100.

As described above, one end of the first coil 310 and the first lead portion 410 may extend to the third surface 103 of the body 100, and one end of the second coil 320 and the second lead portion 420 may extend to the fourth surface 104 of the body 100.

The first and second external electrodes 531 and 541 may be disposed to be spaced apart from each other on the third surface 103 of the body 100 and may be connected to one end of the first coil 310 and the first lead portion 410, respectively. The third and fourth external electrodes 532 and 542 may be disposed to be spaced apart from each other on the fourth surface 104 of the body 100 and may be connected to one end of the second coil 320 and the second lead portion 420, respectively.

The first to fourth external electrodes 531, 541, 532, and 542 may extend to the fifth surface 105 of the body 100. As described above, the fifth surface 105 of the body 100 may serve as the mounting surface when mounting the coil component.

The first to fourth external electrodes 531, 541, 532, and 542 may be formed using a paste containing a metal having excellent t electrical conductivity, such as a conductive paste containing nickel (Ni), copper (Cu), tin (Sn), or silver (Ag), or alloys thereof. In addition, a plating layer may be provided to cover each of the first to fourth external electrodes 531, 541, 532, and 542. In this case, the plating layers may include one or more selected from the group consisting of nickel (Ni), copper (Cu), and tin (Sn). For example, nickel (Ni) layers and tin (Sn) layers may be sequentially formed in the plating layers.

### Second Exemplary Embodiment

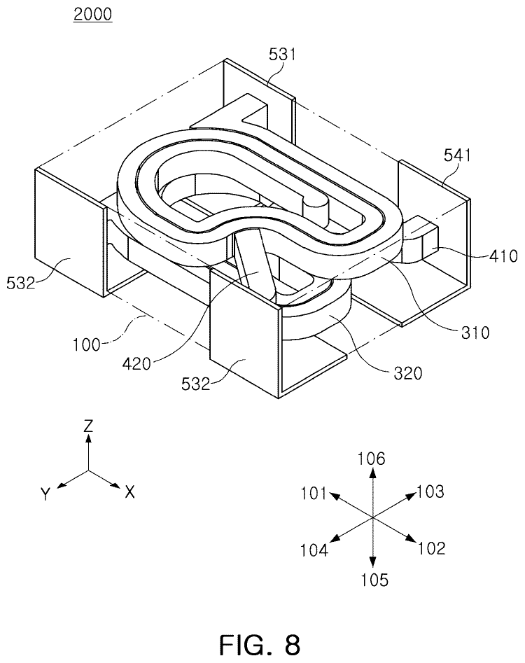

FIG. 8 is a schematic transparent perspective view illustrating a coil component according to a second exemplary embodiment in the present disclosure.

Referring to FIG. 8, a coil component 2000 according to the second exemplary embodiment in the present disclosure is different from the first exemplary embodiment in the presence or absence of the support member 200.

Specifically, the coil component 2000 according to the second exemplary embodiment in the present disclosure may not include the support member 200.

As an example, the coil component 2000 according to the second exemplary embodiment may be a winding type inductor. Specifically, a coil of the coil component 2000 according to the second exemplary embodiment may be a wound coil formed by winding the coil several times.

As another example, the coil component 2000 according to the second exemplary embodiment may be a multilayer inductor. Specifically, the coil component 2000 according to the second exemplary embodiment may be formed by printing coil patterns on a plurality of magnetic sheets and then stacking the plurality of magnetic sheets on which the coil patterns are printed.

However, the coil component 2000 is not necessarily limited thereto, and a coil component that does not include the support member 200 may correspond to the second exemplary embodiment.

A description of other components overlaps with the description of the first exemplary embodiment and will therefore be omitted hereinafter.

As set forth above, according to an exemplary embodiment in the present disclosure, the coil component may enable fine control of the coupling coefficient by adjusting an area of a coil portion shared by two coil portions disposed inside a body in a coil component having a coupled inductor structure.

The coil component according to an exemplary embodiment in the present disclosure may enable efficient control of a characteristic deviation between coil portions in a coil component having a coupled inductor structure.

While example embodiments have been shown and described above, it will be apparent to those skilled in the art that modifications and variations could be made without departing from the scope of the present invention as defined by the appended claims.

What is claimed is:

1. A coil component comprising:
a body having a first surface and a second surface opposing each other in a first direction, a third surface and a fourth surface opposing each other in a second direction, and a fifth surface and a sixth surface opposing each other in a third direction;
a support member disposed inside the body and having one surface and another surface opposing each other;
a first coil disposed on the one surface of the support member and including a first core;
a second coil disposed on the other surface of the support member and including a second core;
a first lead portion disposed on the other surface of the support member and connected to the first coil; and
a second lead portion disposed on the one surface of the support member and connected to the second coil,
wherein the first core partially overlaps the second core when viewed in the third direction of the body, and
a length of the second coil in the first direction is larger than a length of the first coil in the first direction.

2. The coil component according to claim 1, wherein the second coil is disposed closer to the second surface of the body than the first coil.

3. The coil component according to claim 1, wherein a distance between the first coil and the first surface of the body is substantially the same as a distance between the second coil and the first surface of the body.

4. The coil component according to claim 1, wherein an outer end of the first coil and the first lead portion extend to the third surface of the body, and
an outer end of the second coil and the second lead portion extend to the fourth surface of the body.

5. The coil component according to claim 1, further comprising:
a first via connecting an inner end of the first coil and the first lead portion to each other; and
a second via connecting an inner end of the second coil and the second lead portion to each other.

6. The coil component according to claim 5, wherein the first via and the second via are disposed together on a line segment parallel to the second direction of the body.

7. The coil component according to claim 1, wherein the first coil has a first straight portion and a second straight portion, the first straight portion being adjacent to the third surface of the body and being substantially parallel to the third surface of the body, and the second straight portion being adjacent to the fourth surface of the body and being substantially parallel to the fourth surface of the body,
the second coil has a third straight portion and a fourth straight portion, the third straight portion being adjacent to the third surface of the body and being substantially parallel to the third surface of the body, and the fourth straight portion being adjacent to the fourth surface of the body and being substantially parallel to the fourth surface of the body, and
a length of the fourth straight portion is larger than a length of the first straight portion.

8. The coil component according to claim 7, wherein the length of the first straight portion is larger than a length of the second straight portion, and
the length of the fourth straight portion is larger than a length of the third straight portion.

9. The coil component according to claim 7, wherein the first straight portion is disposed closer to the second surface of the body than the second straight portion, and
the fourth straight portion is disposed closer to the second surface of the body than the third straight portion.

10. The coil component according to claim 1, further comprising:
first and second external electrodes connected to an outer end of the first coil and the first lead portion, respectively; and
third and fourth external electrodes connected to an outer end of the second coil and the second lead portion, respectively,
wherein the first and second external electrodes are disposed to be spaced apart from each other on the third surface of the body, and
the third and fourth external electrodes are disposed to be spaced apart from each other on the fourth surface of the body.

11. The coil component according to claim 1, wherein the second coil is disposed closer to the fifth surface of the body than the first coil.

12. A coil component comprising:
a body having a first surface and a second surface opposing each other in a first direction, a third surface and a fourth surface opposing each other in a second direction, and a fifth surface and a sixth surface opposing each other in a third direction;
a first coil disposed inside the body and including a first core; and
a second coil disposed to be spaced apart from the first coil inside the body and including a second core,
wherein the first core includes a first shared core that overlaps the second core in the third direction, and a first non-shared core that does not overlap the second core in the third direction,
the second core includes a second shared core that overlaps the first core in the third direction, and a second non-shared core that does not overlap the first core in the third direction,
the first and second non-shared cores are disposed closer to the second surface of the body than the first and second shared cores, and
an area of the second non-shared core is larger than an area of the first non-shared core.

13. The coil component according to claim 12, wherein the first and second shared cores are disposed closer to the first surface of the body than the first and second non-shared cores.

14. The coil component according to claim 12, wherein the first non-shared core is disposed closer to the sixth surface of the body than the second non-shared core, and
the second non-shared core is disposed closer to the fifth surface of the body than the first non-shared core.

15. The coil component according to claim 12, wherein the first non-shared core is disposed closer to the third surface of the body than the second non-shared core, and
the second non-shared core is disposed closer to the fourth surface of the body than the first non-shared core.

16. The coil component according to claim 12, wherein an area of the first shared core is larger than the area of the first non-shared core, and
an area of the second shared core is larger than the area of the second non-shared core.

17. The coil component according to claim 12, wherein the first coil has a first straight portion and a second straight portion, the first straight portion being adjacent to the third surface of the body and being substantially parallel to the third surface of the body, and the second straight portion being adjacent to the fourth surface of the body and being substantially parallel to the fourth surface of the body, and
the second coil has a third straight portion and a fourth straight portion, the third straight portion being adjacent to the third surface of the body and being substantially parallel to the third surface of the body, and the fourth straight portion being adjacent to the fourth surface of the body and being substantially parallel to the fourth surface of the body.

18. The coil component according to claim 17, wherein the first coil further includes a first curved portion and a second curved portion, the first curved portion extending between one end of the first straight portion and one end of the second straight portion, the second curved portion extending between another end of the first straight portion and another end of the second straight portion, the first curved portion being closer to the first surface of the body than the second curved portion, and
the second coil further includes a third curved portion and a fourth curved portion, the third curved portion extending between one end of the third straight portion and one end of the fourth straight portion, the fourth curved portion extending between another end of the third straight portion and another end of the fourth straight portion, the third curved portion being closer to the first surface of the body than the fourth curved portion.

19. The coil component according to claim 18, wherein the second curved portion and the fourth curved portion each have at least two bent portions so as to form an ‘S’ shape, and
the first curved portion and the third curved portion has a semi-circular shape.

20. The coil component according to claim 19, further comprising:
a first lead portion exposed to the third surface of the body, connected to the first coil, and extending diagonally toward one of the at least two bent portions of the fourth curved portion, and
a second lead portion exposed to the fourth surface of the body, connected to the second coil, and extending diagonally toward one of the at least two bent portions of the second curved portion.
